(19) United States
(12) Patent Application Publication
(10) Pub. No.: US 2012/0317958 A1
(43) Pub. Date: Dec. 20, 2012

(54) METHOD OF OPERATING A MOTOR VEHICLE WITH TWO TURBOCHARGERS

(75) Inventor: ROLF ANDREAS KARCHER, Neckarsulm (DE)

(73) Assignee: Audi AG, Ingolstadt (DE)

(21) Appl. No.: 13/328,355

(22) Filed: Dec. 16, 2011

(30) Foreign Application Priority Data
Dec. 18, 2010 (DE) 10 2010 055 137.6

(51) Int. Cl. F02B 37/12; F02B 37/24; F02B 37/18

(52) U.S. Cl. 60/273

(57) ABSTRACT

In a method of operating a motor vehicle, a temperature is measured of a charge-air flow in flow direction of the charge air downstream of a compressor impeller of each of two turbochargers, and a difference between the temperature of the charge air downstream of the compressor impeller of one of the turbochargers and the temperature of the charge air downstream of the compressor impeller of the other one of the turbochargers is determined. The presence of a difference in the temperatures for the turbochargers is an indication that one of the turbochargers operates at a higher rotational speed so as to allow initiation of preventive measures in order to avoid damage as a result of excessive rotational speed.

### CROSS-REFERENCES TO RELATED APPLICATIONS

This application claims the priority of German Patent Application, Serial No. 10 2010 055 137.6, filed Dec. 18, 2010 pursuant to 35 U.S.C. 119(a)-(d), the content of which is incorporated herein by reference in its entirety as if fully set forth herein.

### BACKGROUND OF THE INVENTION

The present invention relates to a method of operating a motor vehicle with two turbochargers.

The following discussion of related art is provided to assist the reader in understanding the advantages of the invention, and is not to be construed as an admission that this related art is prior art to this invention.

It is generally known in the art to equip motor vehicles with a turbocharger assembly, in which each turbocharger is associated to a group of cylinders, for example a single cylinder bank of a V-engine. Each turbocharger supplies the associated cylinder group with compressed charge air, with exhaust from the cylinder group propelling a turbine wheel of the pertaining turbocharger. This is also referred to as parallel twin-turbo setup. Also known are systems in which several turbochargers deliver into a common volume from which all cylinders are supplied.

The delivery output of the turbochargers must be adjusted in dependence on an operating state of the engine. To manage the pressure of air coming from the compressor, the engine's exhaust gas flow is regulated before it enters the turbine with a wastegate that bypasses excess exhaust gas entering the turbine wheel of the turbocharger. Through variation of the bypassed exhaust gas amount, the rotational speed of the turbocharger can be adjusted. Also known are turbochargers with variable turbine geometry. Using adjustable turbine blades at the turbine entry enables variation of the flow rate of the exhaust gas so that the rotational speed can be adjusted.

Turbochargers are generally configured such that the rotational speed of the turbocharger is slightly below the maximum admissible rotational speed, when the engine operates at full load. In certain situations, the rotational speed of the turbocharger may rise in an unwanted manner, for example as a result of a leak in flow direction of the charge air downstream of the turbocharger or as a result of a significant loss of intake pressure. Setups with several turbochargers run the increased risk of excessive rotational speed when the two turbochargers do not operate in synchronism. In the presence of such a situation during operation of the engine a full load, the rotational speed of the turbocharger may exceed the admissible maximum and cause destruction of the turbocharger.

While it is conceivable to measure the rotational speed directly at the turbocharger, this approach has generally been discarded for cost reasons. There is thus a need for execution of appropriate control measures in order to prevent turbochargers from rotating beyond a maximum admissible rotational speed.

It would therefore be desirable and advantageous to provide an improved method of operating a motor vehicle with two turbochargers to obviate prior art shortcomings.

### SUMMARY OF THE INVENTION

According to one aspect of the present invention, a method of operating a motor vehicle includes measuring a temperature of a charge-air flow in flow direction of the charge air downstream of a compressor impeller of each of two turbochargers, and determining a difference between the temperature of the charge air downstream of the compressor impeller of one of the turbochargers and the temperature of the charge air downstream of the compressor impeller of the other one of the turbochargers.

A method according to the present invention provides a reliable and cost-efficient supervision of turbochargers, using only two temperature sensors. In many instances, the temperature sensors are already present because of their use to provide measurements for a throttle control. By comparing the temperatures between both turbochargers, any influence that is independent from the rotation speed is prevented from impacting the charge-air temperature. Defects that impact the turbocharger speed have an effect only on one of the turbochargers. The second turbocharger can thus be used as reference so that a temperature difference between the two turbochargers provides a reliable indication about an imminent threat that the maximum admissible level of the rotational speed is exceeded.

According to another advantageous feature of the present invention, a rotational speed of at least one of the turbochargers can be reduced, when a magnitude of the difference between the temperatures exceeds a predefined threshold value. For example, the rotational speed of the one of the turbochargers at a higher temperature can be reduced, when a magnitude of the difference between the temperatures exceeds a predefined threshold value. This ensures that the maximum rotational speed of the turbocharger is not exceeded, even in the presence of defects in the charge-air system. As an alternative, the rotational speed of both turbochargers can be reduced, when a magnitude of the difference between the temperatures exceeds a predefined threshold value. This option may find application in motor vehicles which are not equipped with a separate control of the two turbochargers.

According to another advantageous feature of the present invention, the rotational speed of both turbochargers can be reduced by increasing an opening degree of a wastegate of a turbocharger. As a result, a greater quantity of exhaust gas can bypass the turbocharger so that less exhaust gas enters the turbine. The resultant decrease in the charge-air pressure and thus in the engine performance is acceptable in order to be able to ensure a reliable continuous operation of the turbocharger.

According to another advantageous feature of the present invention, the rotational speed of both turbochargers can be reduced by increasing a flow cross section for exhaust gas upon a turbine wheel of the at least one of the turbochargers by adjusting at least one turbine blade. In this way, the speed of the inflowing exhaust gas is reduced so as to decrease the rotational speed of the turbocharger.

According to another advantageous feature of the present invention, a warning signal can be triggered, when the magnitude of the difference between the compared temperatures exceeds the predefined threshold value. In this way, the driver of the motor vehicle can be alerted to arrange for immediate maintenance. Damage caused by continued operation of the motor vehicle can be avoided in the event of defects at the charge-air system or exhaust system.

According to another advantageous feature of the present invention, the predefined threshold value can be selected in dependence on at least a further operating parameter of the motor vehicle. In this way, the maximum admissible temperature difference between the turbochargers can be made dependent on the momentary engine power for example. When the engine power is low so that no significant risk exists that the rotational speed of the turbocharger is exceeded, a greater temperature differential may be permitted.

Further parameters may include control variables for both turbochargers, such as, e.g., a position of the turbine blades. For example, the measured temperature difference can be weighted with the difference between an actual value and a desired value of such a control variable of the turbocharger in order to distinguish, also during normal operation, slight temperature differences from such temperature differences that are caused by defects of the turbocharger or of the charge-air system or the like. It is thus for example possible to recognize a fault even at a slight temperature difference between the turbochargers, when the difference between actual value and desired value of a control variable of the turbocharger is significant. Also, a fault is present even when for example the difference between the actual value and the desired value of the control variable is small but yet a significant temperature difference is encountered.

### BRIEF DESCRIPTION OF THE DRAWING

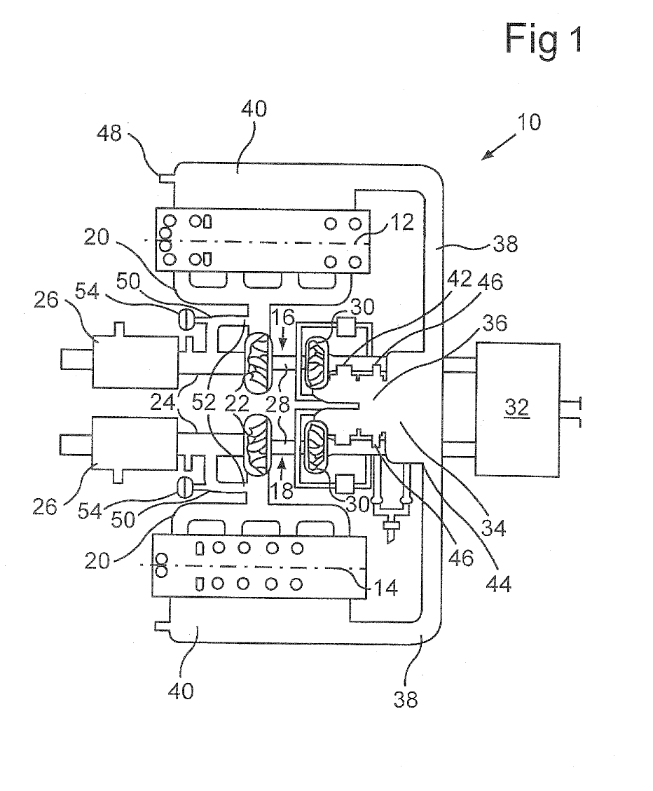

Other features and advantages of the present invention will be more readily apparent upon reading the following description of currently preferred exemplified embodiments of the invention with reference to the accompanying drawing, in which the sole FIG. 1 shows a schematic illustration of an engine with charge-air and exhaust systems for use in a method according to the present invention.

### DETAILED DESCRIPTION OF PREFERRED EMBODIMENTS

The depicted embodiment is to be understood as illustrative of the invention and not as limiting in any way. It should also be understood that the figure is not necessarily to scale and that the embodiment may be illustrated by graphic symbols, phantom lines, diagrammatic representation and fragmentary view. In certain instances, details which are not necessary for an understanding of the present invention or which render other details difficult to perceive may have been omitted.

Turning now to FIG. 1, there is shown a schematic illustration of an engine, generally designated by reference numeral 10 for use in a motor vehicle. By way of example, the engine 10 is configured as 8-cylinder V-shaped engine with two cylinder banks 12, 14. Assigned to the cylinder banks 12, 14 are turbochargers 16, 18, respectively, for charge-air supply of the cylinder banks 12, 14. Both turbochargers 16, 18 are also able to convey charge air into a common intake plenum chamber. Respective manifolds 20 conduct exhaust gas from the cylinder banks 12, 14 to turbine wheels 22 of the turbochargers 16, 18, respectively. Exhaust gas then flow via respective exhaust pipes 24 to catalytic exhaust-gas converters 26.

The turbine wheels 22 propelled by exhaust gas operate compressor impellers 30 of the turbochargers 16, 18 via shafts 28. Ambient air drawn-in via one or more air filters 32 is compressed by the compressor impellers 30 and fed to a charge-air cooler 34. The air flow may hereby be regulated by throttle valves 36. Compressed and cooled air flows from the charge-air cooler via conduits 38 to intake manifolds 40 associated to the cylinder banks 12, 14, respectively, and ultimately into the cylinders of the cylinder banks 12, 14.

Pressure sensors 42, 44 are provided to monitor the charge air, i.e. the pressure of air compressed by the turbochargers 16, 18. Temperature sensor 46 are further arranged upstream of the charge-air cooler 34 in flow direction of charge air to monitor the charge-air temperature.

To adjust the charge-air pressure in dependence on the momentary power output of the engine 10, bypass lines 50 are provided to allow part of the exhaust gas flow to bypass the turbine wheels 22. The amount of exhaust gas conducted through the bypass lines 50 is controlled by so-called wastegate valves 52 which can be controlled by actuators 54, respectively. The greater the amount of exhaust gas conducted through the bypass lines 50 to bypass the turbine wheels 52, the lower the rotational speed of the turbine wheels 22 and thus the charge-air pressure generated by the compressor impellers 30.

In certain situations, for example in the presence of a leak in one of the air conduits 38, the charge-air pressure drops. Maintaining the desired pressure thus requires an increase in the rotational speed of the compressor impellers 30. In particular when the engine 10 runs at full load, the increase in the rotational speed of the compressor impellers 30 may cause the turbochargers 16, 18 to rotate beyond a maximum admissible rotational speed and thud risk damage to the turbochargers 16, 18. To prevent such a scenario, the rotational speed of the turbochargers 16, 18 is monitored in accordance with the present invention through indirect measurement of the temperature of the charge air in flow direction downstream of the compressor impellers 30, using the temperature sensors 46. Pursuant to the general gas equation, this temperature is dependent directly on the extent of compression of charge air by the compressor impellers 30 and thus on the rotational speed of the turbochargers 16, 18. To eliminate the presence of further influencing factors on the temperature of the charge air, a difference of the measured values of the temperature sensors 46 of both turbochargers 16, 18 is determined. A deviation of the difference from zero or a determination that the difference exceeds a predefined threshold value provides an indication that the turbochargers 16, 18 operate at different rotational speeds.

To prevent damage to the turbochargers 16, 18, the rotational speed of the turbochargers needs to be reduced when the magnitude of the temperature difference between the temperature sensors 46 exceeds a predefined threshold value. In a simplest case, the wastegates 52 of both turbochargers 16, 18 are opened. This does not require the provision of a separate control of the actuators 54. Of course, the turbochargers 16, 18 may also be controlled separately. in this case, the wastegate 52 of the one of the turbochargers 16, 18 whose assigned temperature sensor 46 has measured the higher temperature is further opened to lower the rotational speed of that one turbocharger so as to match the rotational speeds between the two turbochargers 16, 18 again. As an alternative, it is also conceivable to increase a flow cross section for exhaust gas upon the turbine wheel 22 of at least one of the turbochargers 16, 18 through adjustment of at least one turbine blade of the turbine wheel 22. In this way, the speed of the inflowing exhaust gas is reduced so as to decrease the rotational speed of the respective turbocharger and thereby again match the rotational speeds between the two turbochargers 16, 18.

To alert a driver of the motor vehicle of a problem when the magnitude of the difference between the compared temperatures exceeds the predefined threshold value so as to allow the drive to schedule for an immediate service, a warning signal can be triggered.

The predefined threshold value can be selected in dependence on at least a further operating parameter of the motor vehicle. In this way, the maximum admissible temperature difference between the turbochargers can be made dependent on the momentary engine power for example. Further parameters may include control variables for both turbochargers 16, 18, such as, e.g. a position of the turbine blades.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of operating a motor vehicle, comprising:
measuring a temperature of a charge-air flow in flow direction of charge air downstream of a compressor impeller of each of two turbochargers; and
determining a difference between the temperature of the charge air downstream of the compressor impeller of one of the turbochargers and the temperature of the charge air downstream of the compressor impeller of the other one of the turbochargers.

2. The method of claim 1, further comprising reducing a rotational speed of at least one of the turbochargers, when a magnitude of the difference between the temperatures exceeds a predefined threshold value.

3. The method of claim 1, further comprising reducing a rotational speed of the one of the two turbochargers at a higher temperature, when a magnitude of the difference between the temperatures exceeds a predefined threshold value.

4. The method of claim 1, further comprising reducing a rotational speed of the two turbochargers, when a magnitude of the difference between the temperatures exceeds a predefined threshold value.

5. The method of claim 2, wherein the reducing step includes increasing an opening degree of a wastegate of the at least one of the turbochargers.

6. The method of claim 2, wherein the reducing step includes increasing a flow cross section for exhaust gas upon a turbine wheel of the at least one of the turbochargers by adjusting at least one turbine blade.

7. The method of claim 2, further comprising triggering a warning signal, when the magnitude of the difference between the temperatures exceeds the predefined threshold value.

8. The method of claim 2, further comprising selecting the predefined threshold value in dependence on at least a further operating parameter of the motor vehicle.
